(19) United States
(12) Patent Application Publication
(10) Pub. No.: US 2023/0265632 A1
(43) Pub. Date: Aug. 24, 2023

(54) INTEGRAL POLYETHYLENE TEREPHTHALATE GRIDS, THE METHOD OF MANUFACTURE, AND USES THEREOF

(71) Applicant: Tensar Corporation, Atlanta, GA (US)

(72) Inventors: Manoj Kumar TYAGI, Fayetteville, GA (US); William Stanley SHELTON, Lithonia, GA (US)

(73) Assignee: Tensar Corporation, Alpharetta, GA (US)

(21) Appl. No.: 18/168,784

(22) Filed: Feb. 14, 2023

Related U.S. Application Data
(63) Continuation of application No. 15/880,932, filed on Jan. 26, 2018, now Pat. No. RE49523.
Application No. 15/880,932 is a reissue of application No. 12/449,379, filed on May 3, 2010, now Pat. No. 9,249,552.
(60) Provisional application No. 60/899,658, filed on Feb. 6, 2007.

(51) Int. Cl. E02D 17/00; B29C 55/04; B29C 55/12; B29D 28/00; E02D 17/20; E02D 31/00

(52) U.S. Cl. CPC E02D 17/00; B29C 55/04; B29C 55/12; B29D 28/00; E02D 17/202; E02D 31/004; Y10T 428/24273; Y10T 428/249921; B29K 2067/003

(57) ABSTRACT

An integral polymer grid with a plurality of interconnected, oriented polyethylene terephthalate strands and an array of openings therein is made from a polyethylene terephthalate sheet-like starting material having perforations or indentations therein that form the openings when the sheet-like material is uniaxially or biaxially stretched. The grid has a higher tensile strength to weight ratio and a higher creep reduced strength to weight ratio than corresponding ratios associated with a grid made from a non-polyethylene terephthalate starting material.

### CROSS-REFERENCE TO RELATED APPLICATION

This application claims the benefit of priority to U.S. Provisional Application for Patent No. 60/899,658 filed Feb. 6, 2007.

### BACKGROUND OF THE INVENTION

### 1. Field of the Invention

The present invention relates generally to integral polymer geogrids and other oriented grids used for structural or construction reinforcement purposes. More particularly, the present invention relates to such integral polymer grids made from homopolymer and copolymer polyethylene terephthalate (“PET”) in order to achieve a higher tensile strength to weight ratio and a higher creep reduced strength to weight ratio.

This invention also relates to the method of producing such integral PET grids. Lastly, the present invention relates to the use of such integral PET grids for soil reinforcement and methods of such reinforcement.

For the purpose of this invention, the terms “integral PET grid” and “integral PET grids” are intended to include integral polyethylene terephthalate geogrids and other integral polyethylene terephthalate grid structures made by orienting (stretching) starting materials in the form of sheets or the like having holes or depressions made or formed therein.

### 2. Description of the Prior Art

Polymeric integral grid structures having mesh openings defined by various geometric patterns of substantially parallel, orientated strands and junctions therebetween, such as geogrids, have been manufactured for over 25 years. Such grids are manufactured by extruding an integrally cast sheet which is subjected to a defined pattern of holes or depressions followed by the controlled uniaxial and biaxial orientation of the sheet into strands and junctions defined by mesh openings formed by the holes or depressions. Orienting the sheet in either the uniaxial or biaxial direction develops strand tensile strength and modulus in the corresponding direction. These integral oriented polymer grid structures can be used for retaining or stabilizing particulate material of any suitable form, such as soil, earth, sand, clay, gravel, etc. and in any suitable location, such as on the side of a road or other cutting or embankment, beneath a road surface, runway surface, etc.

Various shapes and patterns of holes have been experimented with to achieve higher levels of strength to weight ratio, or to achieve faster processing speeds during the manufacturing process. Orientation is accomplished under controlled temperatures and strain rates. Some of the variables in this process include draw ratio, molecular weight, molecular weight distribution, and degree of branching or cross linking of the polymer. As a result of the orientation process, the finished product has a much higher tensile modulus and a highly reduced creep sensitivity.

The manufacture and use of such geogrid and other integral polymer grid structures can be accomplished by well-known techniques. As described in detail in U.S. Pat. No. 4,374,798 to Mercer et al., U.S. Pat. No. 5,419,659 to Mercer et al., U.S. Pat. No. 4,590,029 to Mercer et al., U.S. Pat. No. 4,743,486 to Mercer and Martin, and U.S. Pat. No. 4,756,946 to Mercer, a starting polymeric sheet material is first extruded and then punched to form the requisite defined pattern of holes or depressions.

It is intended that the present invention be applicable to all integral PET grids regardless of the method of forming the starting material or orienting the starting material into the geogrid or grid structure. The subject matter of the foregoing patents is expressly incorporated into this specification by reference as if the patents were set forth herein in their entireties. These patents are cited as illustrative, and are not considered to be inclusive, or to exclude other techniques known in the art for the production of integral polymer grid materials.

Traditionally, the polymeric materials used in the production of integral grids have been high molecular weight homopolymer or copolymer polypropylene, and high density, high molecular weight polyethylene. Various additives, such as ultraviolet light inhibitors, carbon black, processing aids, etc., are added to these polymers to achieve desired effects in the finished product.

While the conventional polypropylene and polyethylene materials exhibit generally satisfactory properties, it is structurally and economically advantageous to produce a grid material having a higher tensile strength to weight ratio and a higher creep reduced strength to weight ratio.

Creep is the process by which the dimensions of a material change with time, while subjected to a sustained or variable load. See, e.g., FIGS. 4 and 5. FIG. 4 illustrates comparative creep curves for various conventional polymeric geotextile materials such as polypropylene and polyester under loading of 40% ultimate strength. FIG. 5 shows representative creep curves for filaments of various polymers.

The creep behavior of a synthetic material is a function not only of polymer type and physical structure, but also of factors such as geometric structure (e.g., woven, nonwoven, integral grid, etc.), surrounding medium, environmental temperature, presence of any micro or macro damage, and aging.

With regard to the temperature factor, polymers creep significantly when exposed to stress above their glass transition temperature, T_{g}. This means that high density polyethylene (“HDPE”) and polypropylene (“PP”), with a T_{g} of −120° C. and −18° C., respectively, creep substantially more at ambient temperature then does PET, which has a T_{g} of 69° C.

Another method of manufacturing grids employs weaving or knitting technology. High tenacity filaments of either PET or polypropylene are twisted together to form yarn. These yarns are either woven or knitted into open structured fabric and then coated with a protective coating to provide protection to the core yarns. The protective coating can be, for example, polyvinyl chloride (PVC), a bituminous substance, or latex. The primary difference between products manufactured using this technology and the aforementioned integral grids is that the woven or knitted products have flexible junctions with considerably low junction strength. Some examples of such grids are the geogrids manufactured by companies such as Merex, Huesker, and Strata. FIG. 13 of the drawings summarizes basic properties of various polymers typically used to produce staple fibers, continuous filaments, and oriented tapes.

Still another method of manufacturing grids uses highly oriented ribs or straps of polyester. The ribs are processed in a welding device in which cross machine direction ribs are introduced and welded together forming dimensional apertures. An example of such a grid is the Secugrid® manufactured by NAUE Gmbh & Co. The junction strength of products manufactured using this method tends to fall between that of integral grids and woven/knit grids.

Therefore, a need exists for an integral polymer material that not only is suitable for use in geogrid service, but that exhibits a higher tensile strength to weight ratio and a higher creep reduced strength to weight ratio than those values associated with conventional geogrid materials.

### SUMMARY OF THE INVENTION

Polyethylene terephthalate (“PET”) is an attractive polymer for use in soil reinforcement projects because it is a relatively low cost commodity polymer, demonstrates high tenacity and low creep behavior, and is fairly resistant to naturally occurring chemicals in soil.

As is evident from its structural formula (below), PET is a much bulkier molecule than polyethylene:

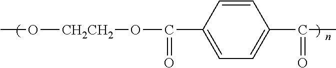

The PET molecule is planar, as required by resonance, but the main chains are not planar due to rotation about the C—O bond. The stiffening action of the p-phenylene group leads to a high melting point and good fiber forming properties.

Accordingly, it is an object of the present invention to produce an integral geogrid or other grid structure from a polyethylene terephthalate starting material according to known process methods, such as those described in the aforementioned U.S. Pat. Nos. 4,374,798, 5,419,659, 4,590,029, 4,743,486, 4,756,946, as well as many other patents.

As indicated above, high density polyethylene and polypropylene, with a T_{g} of −120° C. and −18° C., respectively, creep substantially more at ambient temperature then does polyethylene terephthalate, which has a T_{g} of 69° C. In PET, since the T_{g} is much higher than ambient temperature, creep is largely attributable to steric reorganization of the tightly packed non-crystalline region polymer chain segments, which results in little or no chain slippage.

As a result, a PET material is characterized by a higher creep reduced strength to weight ratio than that of conventional geogrid materials. That is, since PET exhibits much lower creep than does, for example, HDPE, the PET can be used at up to about 70% of ultimate tensile strength, but HDPE only up to about 40%. Accordingly, for an integral geogrid material possessing a specified creep value, an integral PET grid will weigh substantially less than a geogrid using a conventional geogrid material, such as HDPE or PP.

In addition, a PET material is characterized by a higher tensile strength to weight ratio than that of conventional geogrid materials. For example, at comparable stretch ratios, crystalline PET (“CPET”) exhibits almost double the specific strength of HDPE.

Therefore, another object of the present invention is to provide an integral polymer grid made from homopolymer and copolymer polyethylene terephthalate that is characterized by both a higher tensile strength to weight ratio and a higher creep reduced strength to weight ratio than those values associated with integral polymer grids made of conventional geogrid materials.

In addition to the aforementioned structural advantages, PET exhibits good resistance to salts, organic acids, organic solvents, oxidizing agents, reducing agents, and petroleum components, including bitumen often found in soil and related materials. As a result, the integral PET grid according to the present invention is especially attractive for use in soil reinforcement service.

Therefore, still another object of the present invention is to provide an integral polymer grid made from homopolymer and copolymer polyethylene terephthalate that exhibits good resistance to various agents encountered in soil reinforcement service.

These together with other objects and advantages which will become subsequently apparent reside in the details of construction and operation as more fully hereinafter described, reference being had to the accompanying drawings forming a part hereof, wherein like reference numbers refer to like parts throughout. The accompanying drawings are intended to illustrate the invention, but are not necessarily to scale.

### BRIEF DESCRIPTION OF THE DRAWINGS

FIG. 1 illustrates a sample of a crystalline polyethylene terephthalate (CPET) grid according to one embodiment of the present invention in which the starting sheet was uniaxially stretched to a stretch ratio of 3.1:1.

FIG. 2 is a creep test chart showing a creep curve for a CPET sample, initially 3 mm thick, which is uniaxially stretched to a stretch ratio of 5.3:1 and suspended under 60% loading.

FIG. 3 is a creep test chart showing a creep curve for a CPET sample, also initially 3 mm thick, which is uniaxially stretched to a stretch ratio of 5.3:1, but suspended under 70% loading.

FIG. 4 is a graph illustrating comparative creep curves for various polymeric geotextile materials under loading of 40% ultimate strength.

FIG. 5 is a graph illustrating representative creep curves for filaments of various polymers.

FIG. 6 is a table summarizing the tensile test results of the various polymeric samples tested.

FIG. 7 is a chart illustrating the specific strength of the samples shown in FIG. 6.

FIG. 8 is a table summarizing the specific strength of certain representative samples shown in FIG. 7.

FIG. 9 is a chart summarizing the specific strength of the representative samples shown in FIG. 8.

FIG. 10 is a table summarizing the effect of the stretch ratio on the specific strength of a PET sample.

FIG. 11 is a graph depicting the effect of the stretch ratio on the specific strength summarized in FIG. 10.

FIG. 12 is a creep test chart showing a creep curve for a CPET sample, initially 1.4 mm thick, which is stretched to a stretch ratio of 4.25:1 and suspended under 60% loading.

FIG. 13 is a table summarizing basic properties of various polymers typically used to produce staple fibers, continuous filaments, and oriented tapes.

FIG. 14 is a table summarizing the relative chemical resistance of various fiber-forming polymers used in geotextiles.

FIG. 15 is a table summarizing the effect of pH on the tensile strength of various geotextile polymers.

### DETAILED DESCRIPTION OF THE PREFERRED EMBODIMENTS

Although only preferred embodiments of the invention are explained in detail, it is to be understood that the invention is not limited in its scope to the details of construction and arrangement of components set forth in the following description or illustrated in the drawings. The invention is capable of other embodiments and of being practiced or carried out in various ways.

Also, in describing the preferred embodiments, terminology will be resorted to for the sake of clarity. It is intended that each term contemplates its broadest meaning as understood by those skilled in the art, and includes all technical equivalents which operate in a similar manner to accomplish a similar purpose.

In order to understand the behavior and properties of the PET material, and to establish the parameters of using PET to make integral grids, instead of HDPE, standard commercially available extruded sheets of PET were procured. Three types of PET sheets were used: amorphous PET (“APET”), crystalline PET (“CPET”), and PET glycol (“PETG”).

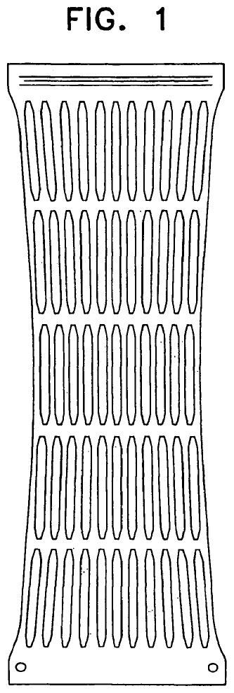

Punched samples for each of the three types of PET sheet were prepared with standard sheet punches such as those used to manufacture HDPE UX products sold by the Tensar International Corporation, Inc. (hereinafter “Tensar”) (Atlanta, Ga.), the assignee of the instant provisional application for patent. For example, FIG. 1 shows a CPET starting sheet sample prepared using a punch (1.53″×0.375″) and uniaxially stretched to a stretch ratio of 3.1:1.

The punched sheet uniaxial stretching was performed on a Tensar laboratory stretcher. Tensar carried out initial laboratory work in accordance with the present invention by stretching narrow strips, i.e., from 2 mm to 4 mm wide, of PET and HDPE to establish the temperature and stretch ratio conditions under which the testing would be conducted. The temperature range was established to be between 100° C. and 240° C., and the stretch ratio range to be between 2:1 and 10:1. These temperature and stretch ratio conditions were then used during stretching of the approximately 8″×10″ punched samples.

For high temperature stretching, i.e., above 160° C., an Instron “Hot-Box” was installed on an Instron Model 1125 tensile testing machine. Standard “dog bone”-shaped samples of CPET, having an initial thickness of 3 mm, were heated to, and then conditioned at, 180° C. for 15 minutes. The heat-conditioned samples were then uniaxially stretched in the lab stretcher in accordance with standard stretching protocols used by Tensar. The samples were stretched to the maximum stretch ratio that was allowed by the size of the Hot-Box, i.e., a ratio of 5.3:1. These 5.3:1 samples were then tested for both tensile and creep properties.

The unstretched and stretched strips and ribs from the 8″×10″ samples were tested for tensile properties on an Instron Model 1125 tensile testing machine using serrated pneumatic grips. The testing grips were padded with cardboard and/or sandpaper to prevent slippage and edge break. The tensile data was normalized for the difference in sheet thickness between the HDPE and the PET by dividing the tensile results by the initial cross-sectional area of the test specimen (i.e., the resultant tensile data has the units of N/mm²). This normalization enabled a material-to-material comparison without the need to standardize the physical dimensions of the test specimens.

Finally, a strength to basis weight comparison was made between standard Tensar HDPE UX products and the 8″×10″ PET punched and stretched samples.

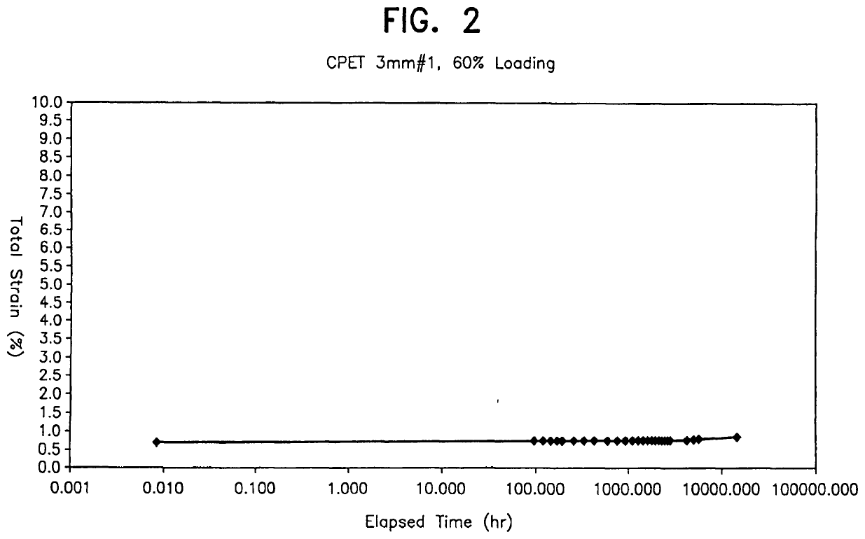

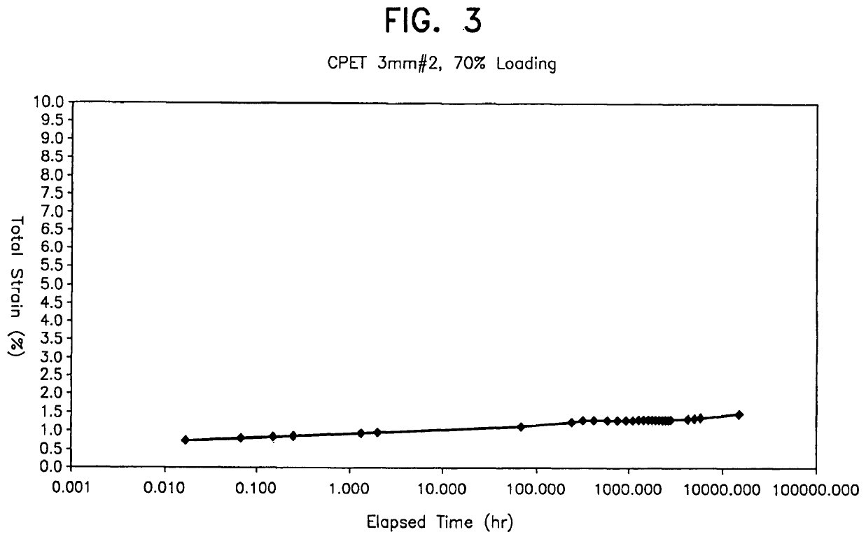

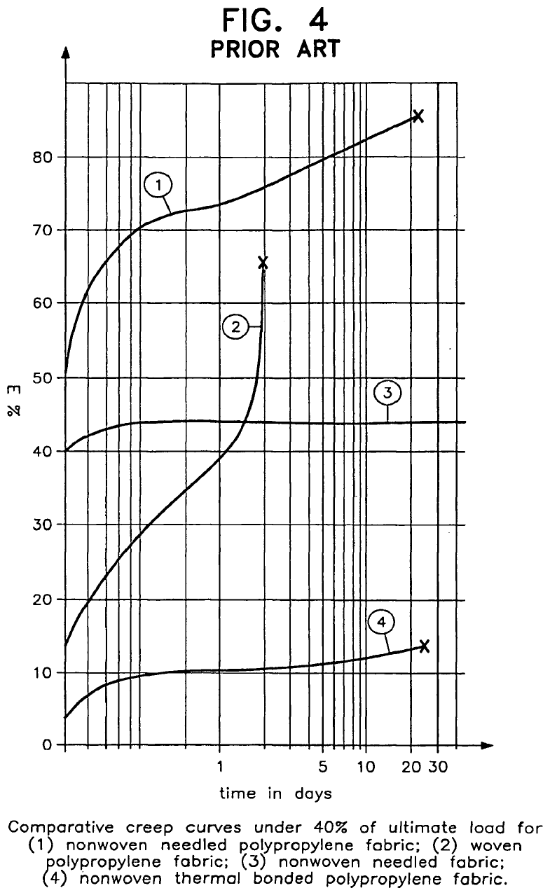

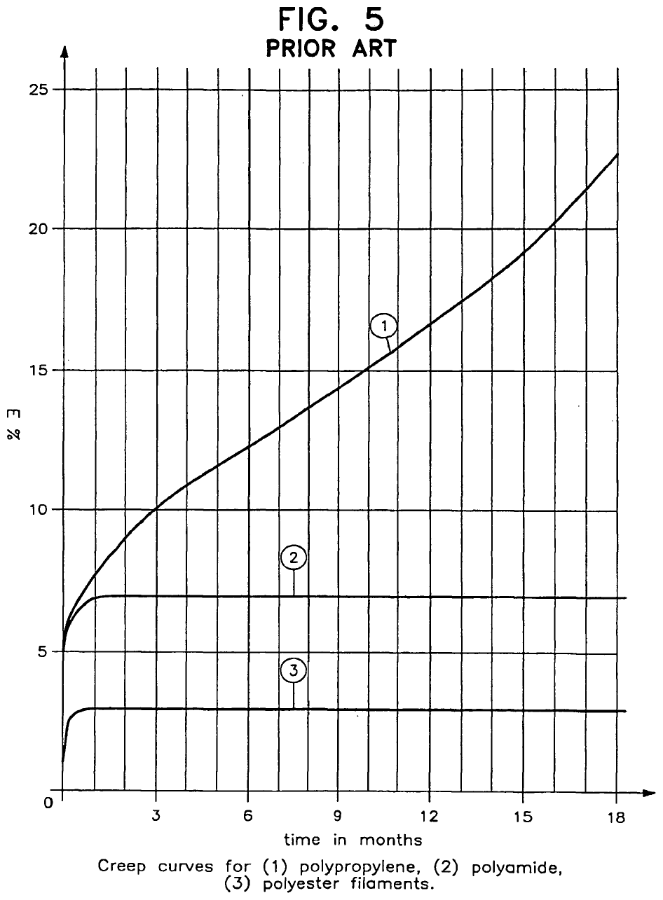

For creep testing, the 5.3:1 stretch ratio samples were suspended under a load at room temperature in a quality control laboratory. One sample was suspended under a load corresponding to 60% of ultimate tensile strength (FIG. 2), and a second sample was suspended under a load corresponding to 70% of ultimate tensile strength (FIG. 3).

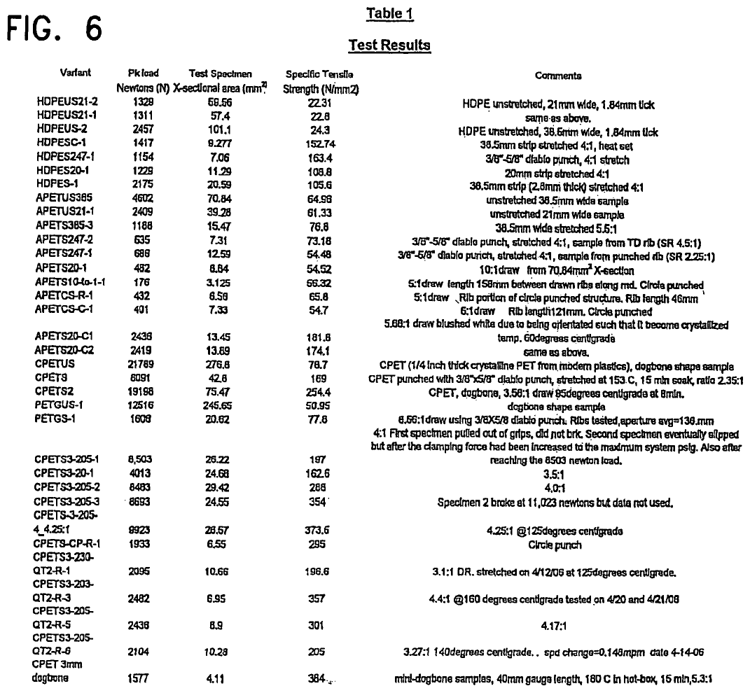

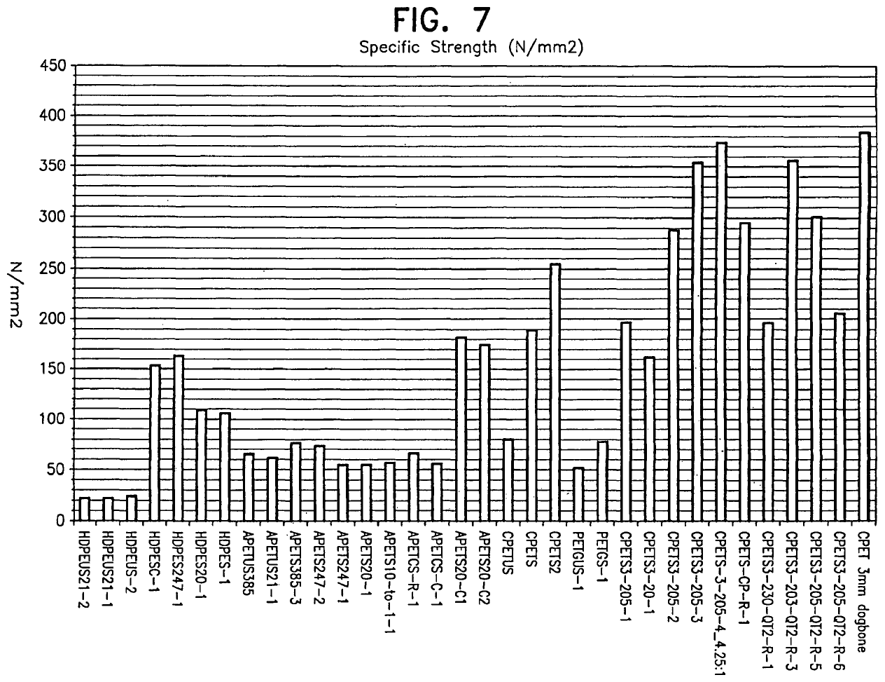

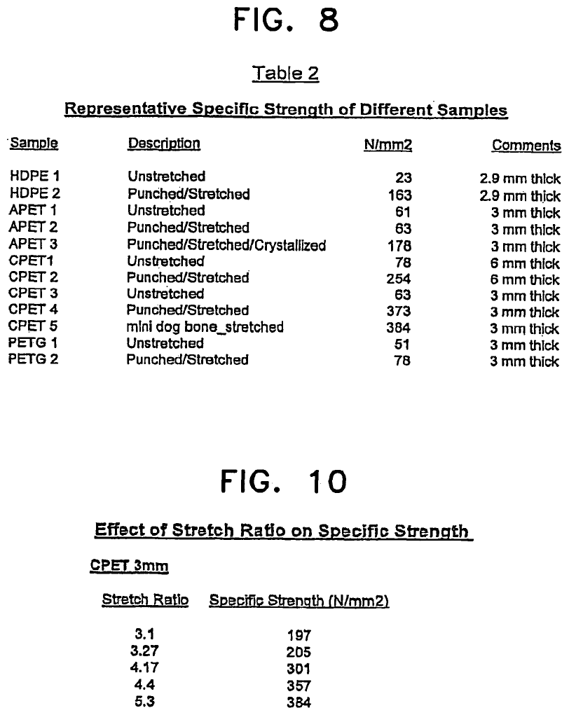

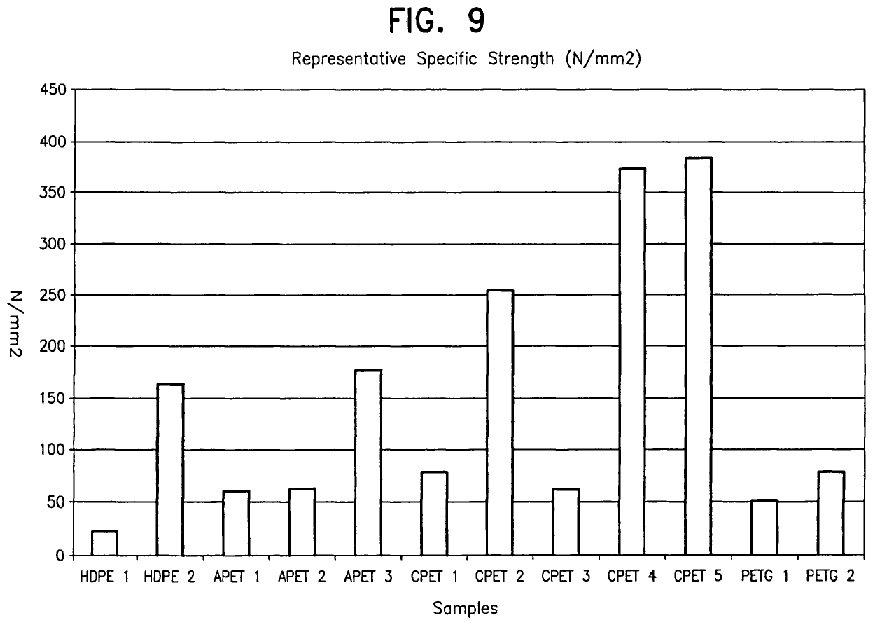

Tensile strength test data associated with the aforementioned 5.3:1 stretch ratio samples is presented in FIGS. 6 and 7. A summary of representative data from FIGS. 6 and 7 is presented in FIGS. 8 and 9. FIG. 8 presents representative specific strength values for each type of polymer at unstretched and maximum stretch ratio conditions.

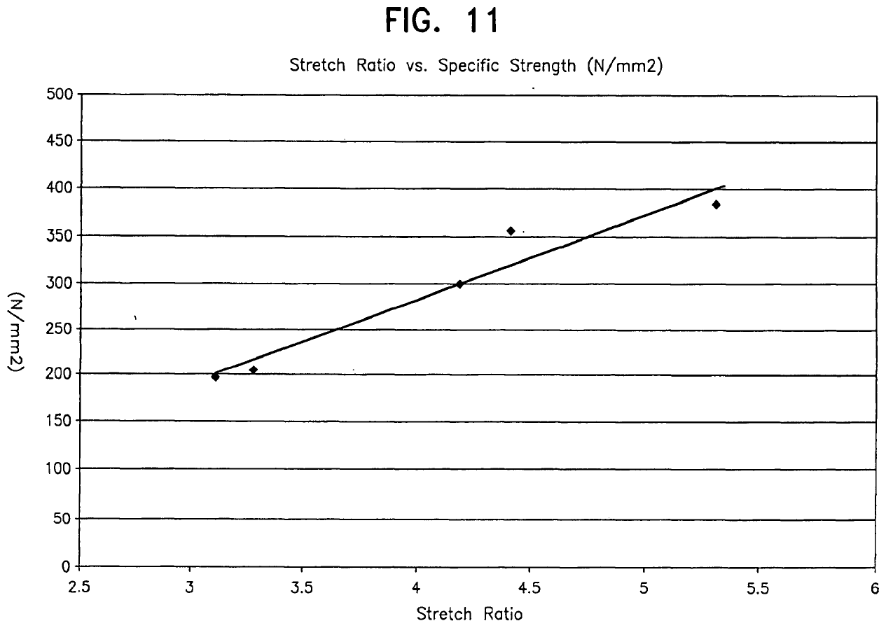

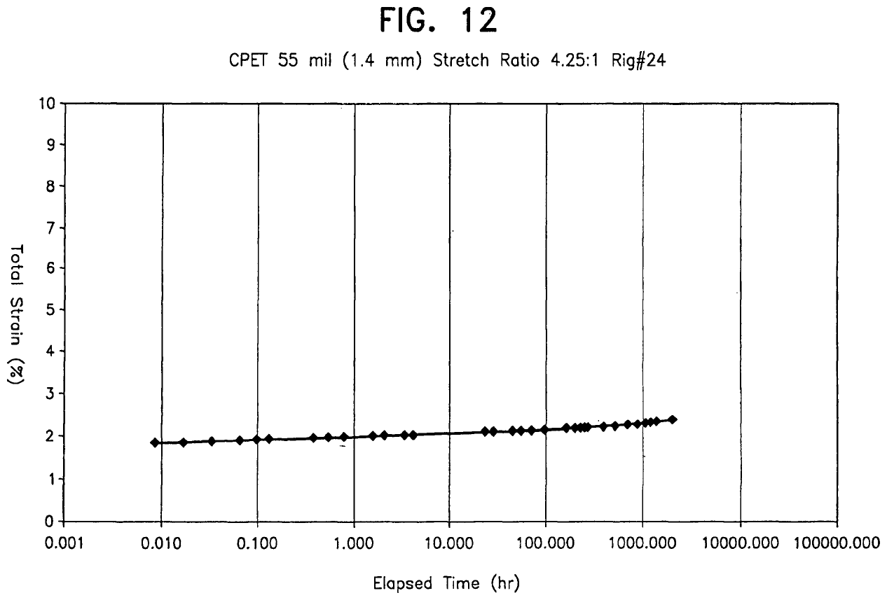

Since the 3 mm thick CPET starting sheet provided the maximum specific strength among the samples summarized in FIGS. 6-8, samples of the 3 mm CPET starting sheet were uniaxially stretched at various ratios of from 3.1:1 to 5.3:1. These results are shown in FIGS. 10 and 11. From this data it is evident that for the 3 mm CPET starting sheet there exists a substantially linear relationship between stretch ratio and specific tensile strength (see FIG. 11).

As is evident from the results presented herein, CPET is a good candidate for the manufacture of extruded and uniaxially stretched integral grids because of a higher specific strength and better creep characteristics. At comparable stretch ratios, CPET exhibits almost double the specific strength of HDPE. That is, as is evident from FIG. 8, sample HDPE 2 (initial thickness of 2.9 mm) has a specific strength of 163 N/mm², while sample CPET 4 (initial thickness of 3 mm) has a specific strength of 373 N/mm².

Since APET starting sheets crystallize during the heated stretching operation, APET starting sheets can achieve a specific strength similar to that of HDPE. But, the required crystallization associated with the heated stretching of APET starting sheets makes the process slow and more expensive. Hence, CPET starting sheets are clearly preferred for the present invention.

The PETG starting sheets did not show any significant difference between unstretched and stretched samples even at a stretch ratio of 8.5:1.

As is evident from FIGS. 2 and 3, the first 5600 hrs of creep data show that there is minimal strain associated with the CPET samples. That is, the strain is only 0.78% at 60% loading, and 1.34% at 70% loading.

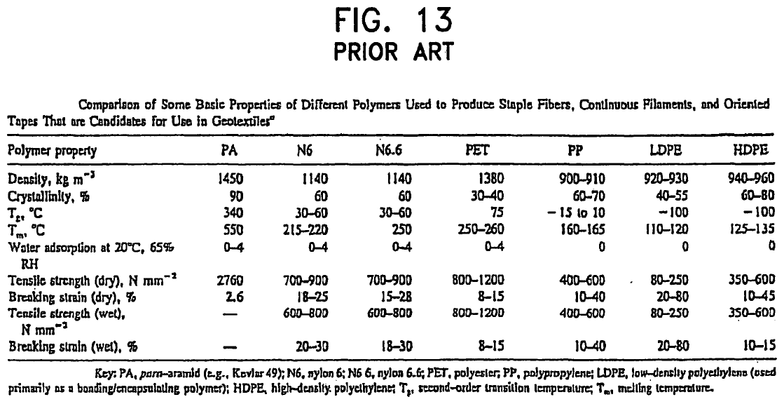

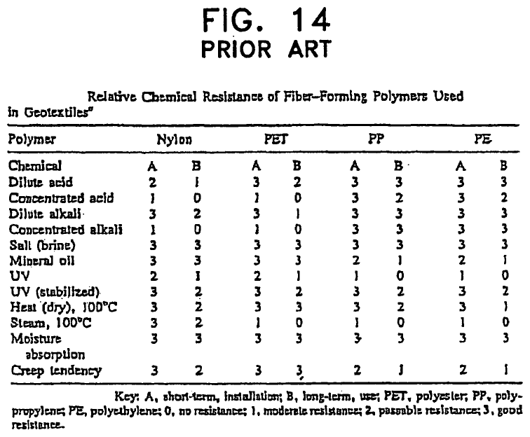

Another test demonstrated the ability to prepare a grid from a CPET sheet having an initial thickness of 1.4 mm. The sample was first punched, then stretched to a stretch ratio of 4.25:1, and finally placed under a loading of 60% of ultimate tensile strength. As is evident from FIG. 12, creep data for the 1.4 mm sample for the first 2000 hours shows a strain of only about 2.4%.

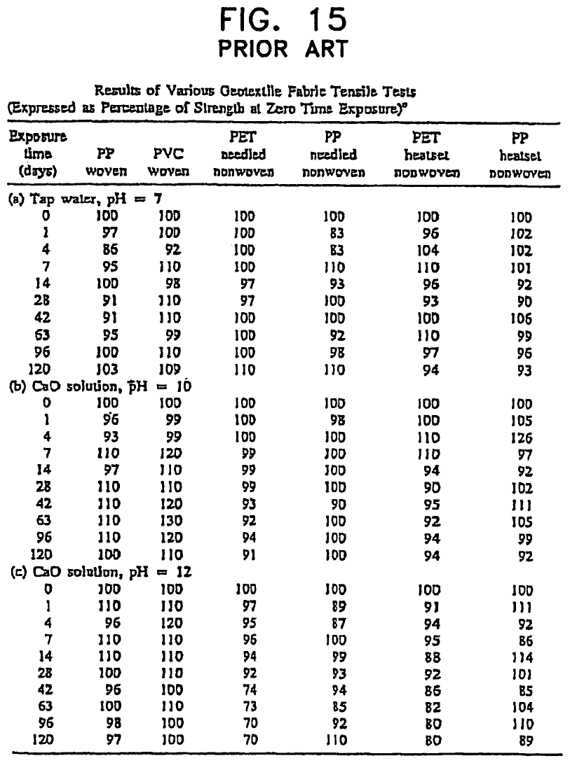

While the integral PET grid according to the present invention exhibits the above-described advantageous characteristics, PET in general can be susceptible to hydrolysis during wet processing and in end use. PET is hydrolyzed by certain acids and by all strong bases, including some organic bases. The factors that can affect this hydrolysis include carboxyl end group (“CEG”), molecular weight, crystallinity, orientation, surface area, temperature, pH level, and the presence of cations. See FIG. 14, which summarizes the relative chemical resistance of various fiber-forming polymers used in geotextiles, and FIG. 15, which summarizes the effect of pH on the tensile strength of various geotextile polymers.

For example, one literature source has proposed that PET hydrolysis is proportional to the square root of the CEG concentration. I. M. Ward, Mechanical Properties of Solid Polymers, Wiley Interscience, New York, 1971. Molecular weight inversely affects the CEG concentration. Hence, a higher molecular weight PET will be less susceptible to hydrolysis. Orientation can also lessen the hydrolytic effect in that it reduces the diffusion rate of the penetrant.

Thus, while there are no specific additives that can retard hydrolysis in PET materials, one or more of the aforementioned variables of CEG, molecular weight, crystallinity, orientation, surface area, temperature, pH, and the presence of cations can be manipulated to improve resistance to hydrolysis.

The foregoing is considered as illustrative only of the principles of the invention. Further, since numerous modifications and changes may readily occur to those skilled in the art, it is not desired to limit the invention to the exact construction and operation described and shown.

What is claimed is:

1. An integral polymer grid comprising a plurality of interconnected, oriented polyethylene terephthalate strands having an array of openings therein.

2. The integral polymer grid according to claim 1, wherein the oriented polyethylene terephthalate strands have been uniaxially or biaxially stretched.

3. The integral polymer grid according to claim 1, wherein the polyethylene terephthalate is a homopolymer or a copolymer.

4. The integral polymer grid according to claim 1, wherein the polyethylene terephthalate is selected from the group consisting of amorphous polyethylene terephthalate, crystalline polyethylene terephthalate, and polyethylene terephthalate glycol.

5. The integral polymer grid according to claim 1, wherein the grid has a higher tensile strength to weight ratio and a higher creep reduced strength to weight ratio than corresponding ratios associated with a grid made from a non-polyethylene terephthalate starting material.

6. The integral polymer grid according to claim 1, wherein the plurality of interconnected, oriented polyethylene terephthalate strands includes transverse strands interconnected by substantially longitudinally oriented strands.

7. The integral polymer grid according to claim 1, wherein the grid is a geogrid configured for structural or construction reinforcement purposes.

8. A starting material for making an integral polymer grid comprising a polyethylene terephthalate sheet-like material having perforations or indentations therein that provide openings when the sheet-like material is uniaxially or biaxially stretched.

9. The starting material according to claim 8, wherein the polyethylene terephthalate is crystalline polyethylene terephthalate.

10. The starting material according to claim 8, wherein the sheet-like material has an initial thickness of at least 3 mm.

11. The starting material according to claim 8, wherein the sheet-like material has an initial thickness of at least 1.4 mm.

12. The starting material according to claim 10, wherein the stretched sheet-like material exhibits a substantially linear relationship between a stretch ratio and a specific tensile strength.

13. A geogrid construction comprising a mass of particulate material strengthened by embedding therein an integral polymer grid as claimed in claim 1.

14. A method of strengthening a mass of particulate material, comprising embedding in the mass of particulate material the integral polymer grid as claimed in claim 1.

15. A method of making an integral polymer grid, comprising orienting a polyethylene terephthalate sheet-like starting material having perforations or indentations therein to provide a plurality of interconnected, oriented polyethylene terephthalate strands and to configure the perforations or indentations as grid openings.

16. The method according to claim 15, wherein the polyethylene terephthalate sheet-like starting material is oriented by uniaxial or biaxial stretching.

17. The method according to claim 15, wherein the polyethylene terephthalate is crystalline polyethylene terephthalate.

18. The method according to claim 17, wherein the sheet-like starting material has an initial thickness of at least 3 mm.

19. The method according to claim 15, further comprising a step of manipulating a variable associated with the polyethylene terephthalate to improve resistance of the integral grid to hydrolysis, the variable being selected from the group consisting of carboxyl end group, molecular weight, crystallinity, orientation, surface area, temperature, pH, and cation presence.

20. A method of providing a geogrid construction, comprising:
uniaxially or biaxially stretching a crystalline polyethylene terephthalate sheet-like starting material having perforations or indentations therein to provide an integral geogrid having a plurality of oriented polyethylene terephthalate strands and a plurality of grid openings; and
embedding the integral geogrid in a mass of particulate material.

21. An integral geogrid comprising a plurality of interconnected, oriented polyethylene terephthalate strands having an array of openings therein that is made from a crystalline polyethylene terephthalate sheet-like starting material having perforations or indentations therein that form the openings when the sheet-like material is uniaxially or biaxially stretched.

22. The integral geogrid according to claim 21, wherein the polyethylene terephthalate strands include substantially transversely oriented strands interconnected by substantially longitudinally oriented strands.
